(19) United States
(12) Patent Application Publication
(10) Pub. No.: US 2014/0225862 A1
(43) Pub. Date: Aug. 14, 2014

(54) TOUCH PANEL

(71) Applicant: Panasonic Corporation, Osaka (JP)

(72) Inventors: Keishiro MURATA, Kyoto (JP); Koji TANABE, Osaka (JP)

(73) Assignee: PANASONIC CORPORATION, Osaka (JP)

(21) Appl. No.: 14/157,320

(22) Filed: Jan. 16, 2014

(30) Foreign Application Priority Data
Feb. 13, 2013 (JP) 2013-025194
Oct. 8, 2013 (JP) 2013-210787

(51) Int. Cl. G06F 3/044

(52) U.S. Cl. CPC G06F 3/044
USPC 345/174

(57) ABSTRACT

A touch panel includes an operation surface, a plurality of light-transmitting belt-like first conductive layers, belt-like second conductive layers, low-reflective layers, and a substrate. Each of the second conductive layers includes conductive parts and connecting parts. The conductive parts are formed between the plurality of first conductive layers. Each of the connecting parts is insulated from the first conductive layers, crosses over the first conductive layers, and electrically connects adjacent conductive parts. The low-reflective layers are formed between the connecting parts and the operation surface. The substrate supports the first conductive layers, the second conductive layers and the low-reflective layers. The surfaces of the low-reflective layers have lower light reflectivity than that of the surfaces of the connecting parts.

### BACKGROUND OF THE INVENTION

1. Field of the Invention

The present technical field relates to a touch panel mainly used for operations of various electronic apparatuses.

2. Background Art

Recently, various electronic apparatuses such as portable telephones and electronic cameras have had more advanced functions and become diversified. Electronic apparatuses including a light-transmitting touch panel mounted to a display screen such as a liquid crystal display device have been used. A user operates a touch panel with a finger or the like while the user views a display screen on a back surface via the touch panel, and thereby various functions of the electronic apparatus are changed. In such a touch panel, improvement of visibility has been demanded.

FIG. 8 is a sectional view of conventional touch panel 10. FIG. 9 is a plan view of conventional touch panel 10. For easy understanding of configurations in these drawings, dimensions are partially enlarged. Light-transmitting first conductive layers 2 are formed on light-transmitting film-like substrate 1. First conductive layers 2 and conductive parts 3A are made of, for example, indium tin oxide.

Each of first conductive layers 2 is formed in a belt-like shape in which corner portions of a plurality of square-shaped electrodes 8 are connected to each other. The plurality of belt-like first conductive layers 2 is formed in stripes in a front-and-back direction of substrate 1. Herein, the front-and-back direction denotes a short-side direction of touch panel 10 in FIG. 9 and a right-and-left direction denotes a long-side direction thereof.

Since each of electrodes 8 of first conductive layer 2 has a square shape, square-shaped gap portions are formed between the adjacent first conductive layers 2. On the gap portions, square-shaped conductive parts 3A are formed.

Adjacent conductive parts 3A are electrically coupled to each other by connecting parts 3B which bridge first conductive layers 2. With this configuration, belt-like second conductive layers 3 are formed in the right-and-left direction of substrate 1. That is to say, second conductive layers 3 are formed perpendicular to first conductive layers 2 on substrate 1. Connecting parts 3B are made of, for example, a copper alloy.

Insulating part 4 is provided between the lower part of each of connecting parts 3B and the upper part of each of first conductive layers 2 such that first conductive layers 2 and second conductive layers 3 are not electrically connected to each other.

First electrodes 5A extend toward the right end of the outer periphery of substrate 1 from end portions of first conductive layers 2. First electrodes 5A are made of, for example, silver, carbon, a copper foil, and the like.

Second electrodes 5B extend toward the right end of the outer periphery of substrate 1 from end portions of second conductive layers 3. Second electrodes 5B are made of, for example, silver, carbon, a copper foil, and the like.

Light-transmitting insulating layer 6 is formed so as to cover the upper surface of substrate 1 excluding the end portions of first electrodes 5A and second electrodes 5B extending toward the right end of the outer periphery of substrate 1. Film-like or plate-like cover 7 is bonded to the upper surface of insulating layer 6 with an adhesive (not shown) and the like. Thus, touch panel 10 is formed.

Touch panel 10 is mounted to an electronic apparatus (not shown) such that the lower surface of substrate 1 faces a display screen such as a liquid crystal display device (not shown). The end portions of first electrodes 5A and the end portions of second electrodes 5B are connected to an electronic circuit (not shown) of the electronic apparatus.

Next, an operation of touch panel 10 is described.

When a user touches to operate a menu screen displayed on a display screen of an electronic apparatus with a finger via touch panel 10, a capacitance of first conductive layers 2 and second conductive layers 3 in a position corresponding to the operated position is changed. Then, the change is detected by an electronic circuit, and the position on the screen which the user operates is specified.

For example, a user touches the upper surface of cover 7 over a portion corresponding to a desired menu in a state in which a plurality of menus is displayed on a display screen on the back surface. Then, a part of electric charge is moved to a finger, and a capacitance is changed between first conductive layers 2 and second conductive layers 3 of touch panel 10 which the user operates. The change is detected by the electronic circuit, so that the desired menu is selected.

Note here that as prior art information related to this application, for example, Japanese Patent Application Unexamined Publication No. 2012-181828 is known.

### SUMMARY OF THE INVENTION

A touch panel includes an operation surface, a plurality of light-transmitting belt-like first conductive layers, belt-like second conductive layers, low-reflective layers, and a substrate. Each of the second conductive layers includes conductive parts and connecting parts. The conductive parts are formed between the plurality of first conductive layers. Each of the connecting parts is insulated from the first conductive layers, crosses over the first conductive layers, and electrically connects adjacent conductive parts. The low-reflective layers are formed between the connecting parts and the operation surface. The substrate supports the first conductive layers, the second conductive layers and the low-reflective layers. The surfaces of the low-reflective layers have lower light reflectivity than that of the surfaces of the connecting parts.

### BRIEF DESCRIPTION OF THE DRAWINGS

FIG. 1 is a sectional view of a touch panel in accordance with an embodiment.

FIG. 2 is a plan view of the touch panel in accordance with the present embodiment.

FIG. 3A is a sectional view for illustrating a method of manufacturing the touch panel in accordance with the present embodiment.

FIG. 3B is a sectional view for illustrating the method of manufacturing the touch panel in accordance with the present embodiment.

FIG. 3C is a sectional view for illustrating the method of manufacturing the touch panel in accordance with the present embodiment.

FIG. 4A is a sectional view for illustrating the method of manufacturing the touch panel in accordance with the present embodiment.

FIG. 4B is a sectional view for illustrating the method of manufacturing the touch panel in accordance with the present embodiment.

FIG. 4C is a sectional view for illustrating the method of manufacturing the touch panel in accordance with the present embodiment.

FIG. 5 is a sectional view of another touch panel in accordance with the present embodiment.

FIG. 6A is a sectional view of a work-in-process of another touch panel in accordance with the present embodiment.

FIG. 6B is a sectional view of another touch panel in accordance with the present embodiment.

FIG. 7A is a sectional view of still another touch panel in accordance with the present embodiment.

FIG. 7B is a sectional view of yet another touch panel in accordance with the present embodiment.

FIG. 8 is a sectional view of a conventional touch panel.

FIG. 9 is a plan view of a conventional touch panel.

### DETAILED DESCRIPTION OF THE INVENTION

In conventional touch panel 10, connecting parts 3B that connect conductive parts 3A are made of conductive metal such as a copper alloy. When a display screen is bright, for example, when a whole surface of the display screen of an electronic apparatus is lighted, connecting parts 3B are not distinguished. However, when the display screen is dark, for example, when light of the display screen is turned off, external light such as sunlight and lamp light is reflected by connecting parts 3B, which may make it difficult to see the display screen.

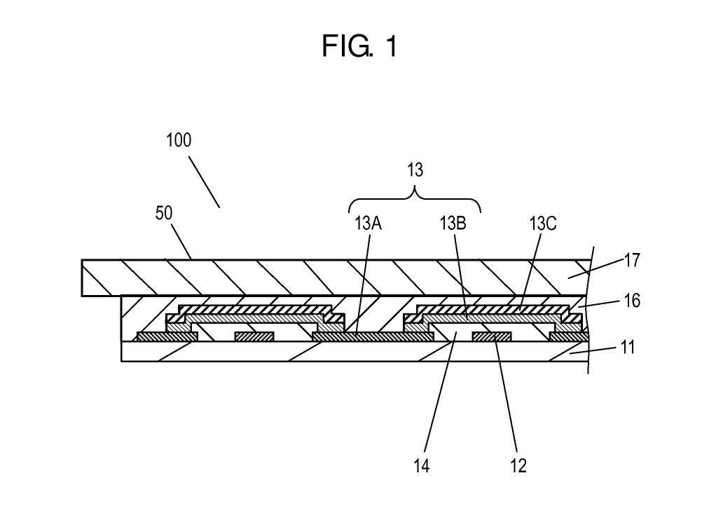

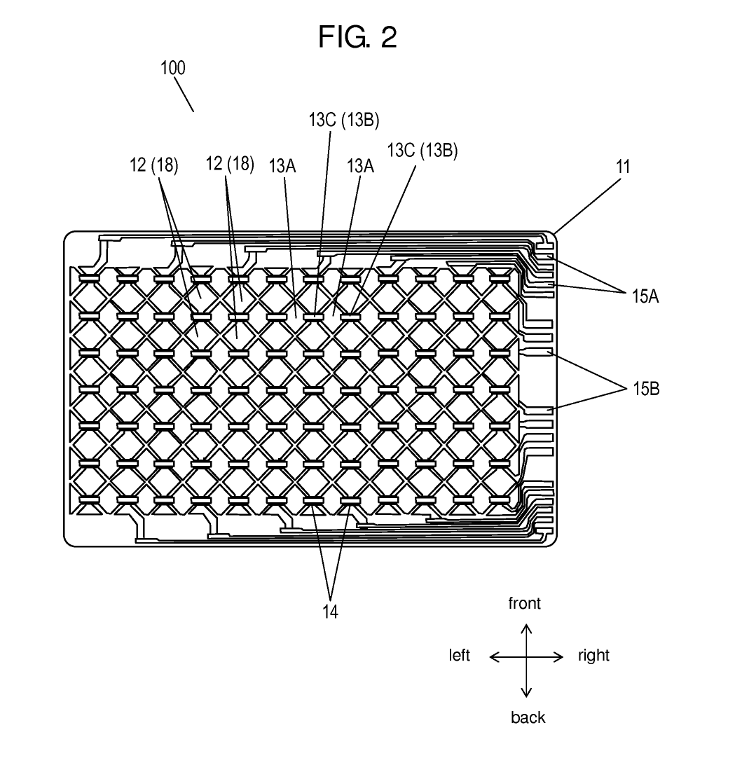

FIG. 1 is a sectional view of touch panel 100 in accordance with the present embodiment. FIG. 2 is a plan view of touch panel 100 in accordance with the present embodiment. For easy understanding of a configuration in these drawings, dimensions are partially enlarged.

Touch panel 100 has operation surface 50, and it includes a plurality of light-transmitting belt-like first conductive layers 12, belt-like second conductive layers 13, low-reflective layers 13C, and substrate 11. Each of second conductive layers 13 includes conductive parts 13A and connecting parts 13B. Each of conductive parts 13A is formed between the plurality of first conductive layers 12. Connecting part 13B is insulated from first conductive layers 12, crosses over first conductive layers 12, and electrically connects adjacent conductive parts 13A. Low-reflective layer 13C is formed between connecting part 13B and operation surface 50. Substrate 11 supports first conductive layers 12, second conductive layers 13, and low-reflective layers 13C. Surfaces of low-reflective layers 13C have lower light reflectivity than that of surfaces of connecting parts 13B.

Light-transmitting first conductive layer 12 is formed on the upper surface of light-transmitting film-like substrate 11. Substrate 11 is made of, for example, polyethylene terephthalate, polyether sulphone, polycarbonate, and the like. First conductive layer 12 and conductive part 13A are made of conductive material such as indium tin oxide (ITO) and tin oxide.

Each of first conductive layers 12 is formed in a belt-like shape in which corner portions of a plurality of square-shaped electrodes 18 are connected to each other. The plurality of belt-like first conductive layers 12 is formed in stripes in a front-and-back direction of substrate 11. Herein, the front-and-back direction denotes a short-side direction of touch panel 100 in FIG. 2 and the right-and-left direction denotes a long-side direction thereof.

Since each of electrodes 18 of first conductive layers 12 has a square shape, square-shaped gap portions are formed between the adjacent first conductive layers 12. On the gap portions, square-shaped conductive parts 13A are formed.

Adjacent conductive parts 13A are electrically connected to each other by connecting parts 13B that bridge first conductive layers 12. Connecting part 13B has conductivity, and are made of copper, silver, iron, nickel, chromium, ruthenium, tungsten, molybdenum, manganese, cobalt, and alloy thereof. The width of each conductive part 13A is about 1 μm or more and 100 μm or less.

Second conductive layer 13 is formed of conductive part 13A and connecting part 13B.

On the upper surface of connecting part 13B, low-reflective layer 13C made of oxide and nitride of, for example, copper, silver, iron, nickel, chromium, ruthenium, tungsten, molybdenum, manganese, cobalt, and an alloy thereof by vapor deposition, sputtering, or the like.

Note here that the surfaces of low-reflective layers 13C reflect light less than the surfaces of connecting parts 13B or conventional connecting parts 3B. That is to say, the surfaces of low-reflective layers 13C have lower light reflectivity than the surfaces of connecting parts 13B. When the upper surface of low-reflective layer 13C is made to have a dark color, reflection of light from the outside can be suppressed. Furthermore, it is preferable that low-reflective layer 13C is formed such that not only the color of the surface is made to be dark but also the shape of the surface is made to have small concavities and convexities for suppressing reflection of light. It is preferable that the concavities and convexities have a size of 0.1 μm or more and 1.0 μm or less.

Second conductive layers 13 are formed in a belt shape in the right-and-left direction of substrate 11. That is to say, second conductive layers 13 are formed in the direction perpendicular to first conductive layers 12. Then, the plurality of belt-like second conductive layers 13 is formed in stripes in the right-and-left direction of substrate 11.

Insulating part 14 is formed between first conductive layer 12 and conductive part 13A by printing or by exposure and development such that first conductive layer 12 and conductive part 13A are not electrically connected to each other. In other words, between the lower part of connecting part 13B and the upper part of first conductive layer 12, light-transmitting insulating part 14 is formed. Insulating part 14 is made of acrylate, methacrylate, epoxy, or the like. With insulating part 14, insulating property between first conductive layer 12 and second conductive layer 13 is maintained.

First electrodes 15A extend toward the right end of the outer periphery of substrate 11 from end portions of first conductive layers 12.

Second electrodes 15B extend toward the right end of the outer periphery of substrate 11 from end portions of second conductive layers 13.

Insulating layer 16 is formed so as to cover the upper surface of substrate 11 excluding the end portions of first electrodes 15A and second electrodes 15B, which extend to the right end of the outer periphery of substrate 11. Note here that insulating layer 16 is made of light-transmitting insulating raw material such as acrylate, methacrylate, epoxy, or the like.

Film-like or plate-like cover 17 is bonded to the upper surface of insulating layer 16 with an adhesive (not shown). Thus, touch panel 100 is formed. Cover 17 is made of light-transmitting insulating raw material such as polycarbonate, acrylic, and glass.

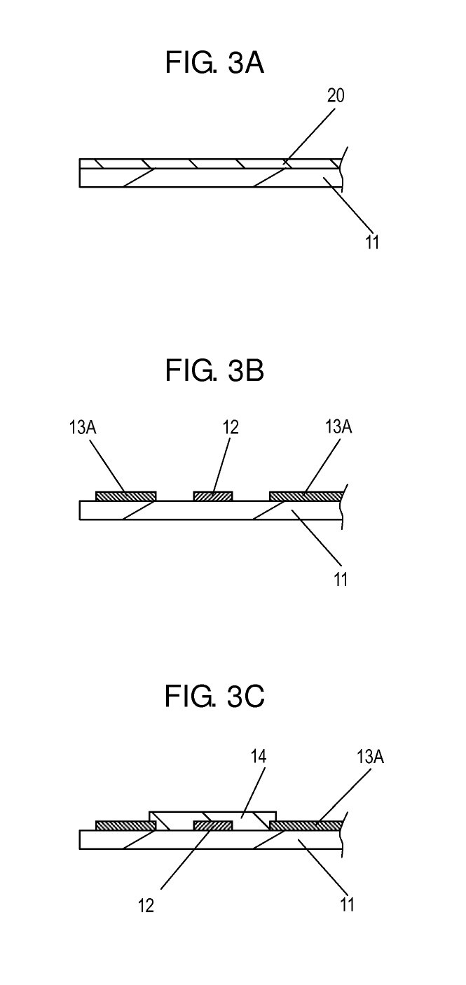

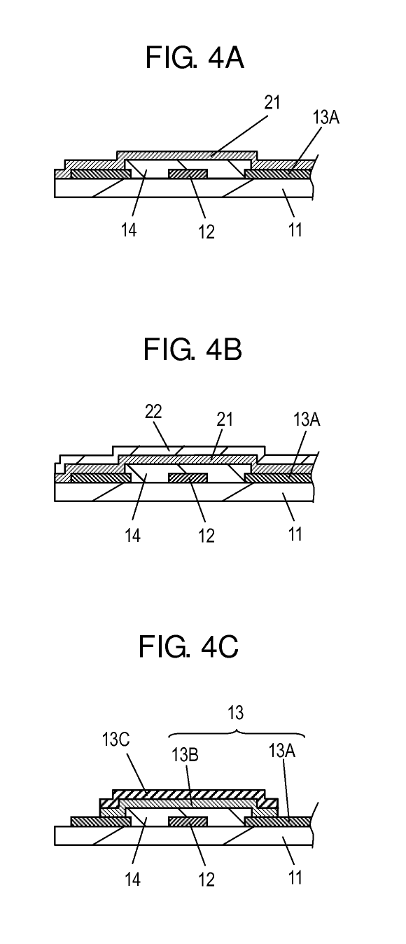

Next, an example of a manufacturing method of the above-mentioned touch panel 100 is described with reference to drawings. FIGS. 3A to 3C and FIGS. 4A to 4C are sectional views for illustrating a method of manufacturing touch panel 100 in accordance with the present embodiment.

As shown in FIG. 3A, thin film 20 of indium tin oxide or the like is formed on an entire surface of substrate 11 by vapor deposition, sputtering, or the like. The film thickness of thin film 20 is about several tens nm. Thereafter, a photoresist film (not shown) such as a dry film resist is formed on the surface of thin film 20, selective exposure is carried out via a photo mask (not shown) and the like, followed by developing thereof. Thus, patterning of the photoresist film is carried out. Thereafter, substrate 11 is immersed in a predetermined etchant (not shown) to dissolve and remove thin film 20 in an unnecessary part. Thereafter, the photoresist film is removed.

Thus, as shown in FIG. 3B, a plurality of first conductive layers 12 and plurality of conductive parts 13A are formed. That is to say, first conductive layers 12 and conductive parts 13A are made of the same material on the same plane. With such a configuration, first conductive layers 12 and conductive parts 13A can be formed at one time.

Next, as shown in FIG. 3C, insulating part 14 is formed so as to cover first conductive layer 12 between a plurality of conductive parts 13A by printing or by exposure and development.

Next, as shown FIG. 4A, thin film 21 of copper, nickel, chromium, an alloy thereof, and the like, is provided by vapor deposition or sputtering on the entire surface of the upper surface of a work-in-process shown in FIG. 3C. The film thickness of thin film 21 is about 100 nm or more and 200 nm or less.

Furthermore, as shown in FIG. 4B, thin film 22 of oxide and nitride of copper, nickel, chromium, an alloy thereof, and the like, is provided on the thin film 21 by, for example, vapor deposition or sputtering. The film thickness of thin film 22 is several tens nm.

Thereafter, a photoresist film (not shown) such as a dry film resist is formed on a surface of thin film 22 by carrying out selective exposure, via a photo mask (not shown) and the like, followed by development. Thus, patterning of the photoresist film is carried out. Thereafter, substrate 11 is immersed in a predetermined etchant (not shown) to dissolve and remove thin films 21 and 22 in an unnecessary part. Thereafter, the photoresist film is removed.

Thus, as shown in FIG. 4C, thin film 21 is made into connecting part 13B, and thin film 22 is made into low-reflective layer 13C. Then, conductive parts 13A are connected to each other by connecting parts 13B, belt-like second conductive layers 13 including low-reflective layer 13C on connecting parts 13B are formed.

Furthermore, at the same time when connecting part 13B and low-reflective layer 13C are formed, first electrode 15A and second electrode 15B are formed. That is to say, first electrode 15A and second electrode 15B are formed of thin film 21 and thin film 22, respectively. In other words, first electrode 15A and second electrode 15B are formed by forming oxide and nitride of copper, nickel, chromium, and an alloy thereof on copper, nickel, chromium, and an alloy thereof. However, first electrode 15A and second electrode 15B may be formed separately from connecting part 13B and low-reflective layer 13C. For example, first electrode 15A and second electrode 15B may be made of material such as silver, carbon, and a copper alloy by printing, vapor deposition, or the like.

Furthermore, light-transmitting insulating layer 16 is formed so as to cover the upper surface of substrate 11 excluding the end portions of first electrode 15A and first electrode 15B extending toward the right end of the outer periphery of substrate 11 by printing or the like. Thereafter, by bonding cover 17 thereto, touch panel 100 shown in FIG. 1 is formed. That is to say, in touch panel 100, first conductive layers 12 are formed on substrate 11, insulating parts 14 are formed on first conductive layers 12, connecting parts 13B are formed on insulating parts 14, and low-reflective layers 13C are formed on connecting parts 13B.

Touch panel 100 formed as mentioned above is disposed such that a lower surface of substrate 11 faces a display screen of a liquid crystal display device (not shown), and mounted to an electronic apparatus (not shown). Note here that the end portion of first electrode 15A and the end portion of second electrode 15B are connected to an electronic circuit (not shown) of the electronic apparatus. In FIG. 1, operation surface 50 is an upper surface of cover 17.

Next, an operation of touch panel 100 is described.

A voltage is applied from the electronic circuit to a plurality of first electrodes 15A and second electrodes 15B. In this state, a user carries out operations by touching operation surface 50 with a finger or the like while the user views a menu screen displayed on a display screen via touch panel 100. Then, a capacitance of first conductive layer 12 and second conductive layer 13 in a position corresponding to the operated position is changed. Then, the change is detected by the electronic circuit, and the position on the screen which the user operates is specified.

As mentioned above, in touch panel 100, low-reflective layers 13C are provided on the upper surfaces of connecting parts 13B for connecting conductive parts 13A to each other. In other words, low-reflective layer 13C is formed at an operation surface 50 side of connecting part 13B. Consequently, the upper surface of low-reflective layer 13C absorbs light and does not easily reflect light.

That is to say, external light such as sunlight and lamp light entering from the outside of cover 17 is absorbed by the upper surface of low-reflective layer 13C so as to prevent the external light from being reflected.

Thus, when light of the display screen of the electronic apparatus is turned out, external light entering from the outside of cover 17 is absorbed by the upper surface of low-reflective layer 13C formed on connecting part 13B. As a result, since less light is reflected, a touch panel having excellent visibility of the display screen is obtained.

Note here that touch panel 100 is formed by forming first conductive layers 12 and conductive parts 13A on the upper surface of substrate 11, followed by laminating insulating part 14, connecting part 13B and low-reflective layer 13C in this order. However, this embodiment is not limited to this configuration.

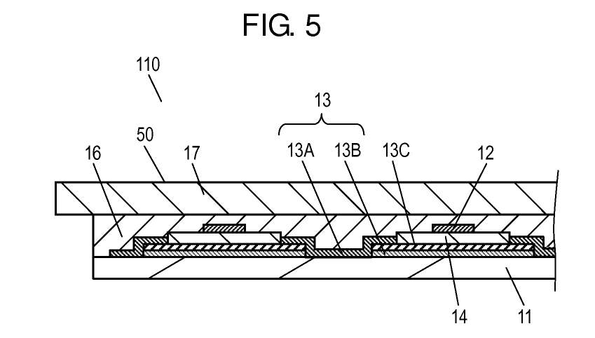

FIG. 5 is a sectional view of touch panel 110 in accordance with the present embodiment. As shown in FIG. 5, first conductive layer 12 and conductive parts 13A may be formed after laminating connecting parts 13B, low-reflective layers 13C, and insulating parts 14 in this order from the upper surface of substrate 11. That is to say, in touch panel 110, connecting parts 13B are formed on substrate 11, low-reflective layers 13C are formed on connecting parts 13B, insulating parts 14 are formed on low-reflective layers 13C, and first conductive layers 12 are formed on insulating parts 14.

First conductive layers 12 of touch panel 110 are also formed in a belt shape in which corners of a plurality of square-shaped electrodes 18 are connected to each other. Then, conductive part 13A is formed in a square shape in a square-shaped gap portion.

Connecting parts 13B and low-reflective layers 13C are electrically connected to conductive parts 13A. Conductive part 13A and connecting part 13B form second conductive layer 13.

Light-transmitting insulating layer 16 is formed so as to cover first conductive layers 12, conductive parts 13A, and insulating parts 14. Cover 17 is bonded to the upper surface of insulating layer 16. Then, the lower surface of substrate 11 is mounted to a display screen such as a liquid crystal display device (not shown). In FIG. 5, operation surface 50 is an upper surface of cover 17.

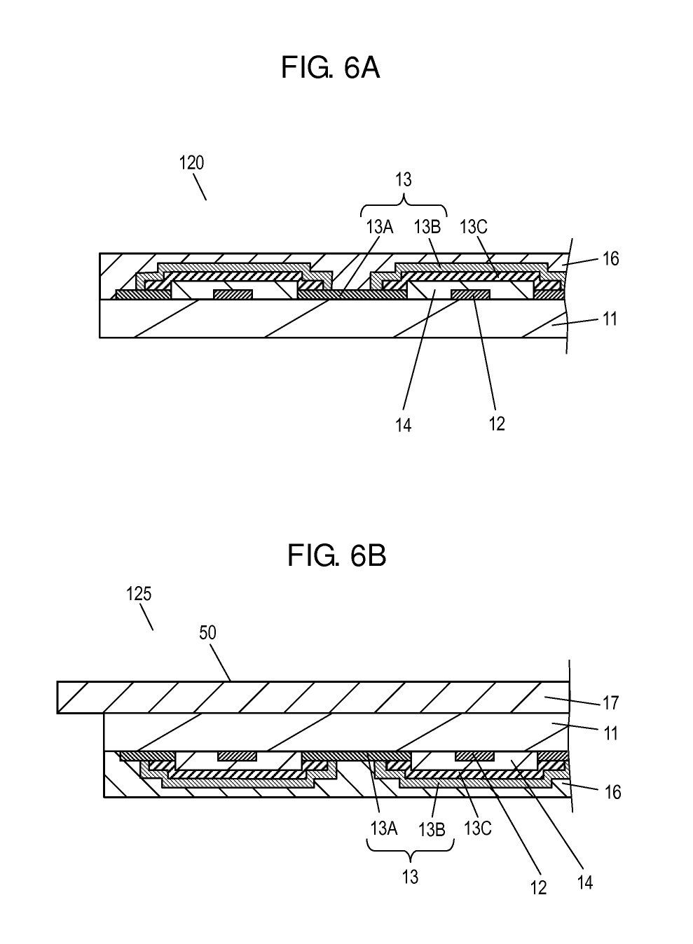

FIG. 6A is a sectional view of work-in-process 120 of touch panel 125 in accordance with the present embodiment. FIG. 6B is a sectional view of touch panel 125 in accordance with the present embodiment.

As work-in-process 120, first conductive layers 12 and conductive parts 13A are formed on the upper surface of substrate 11. Insulating part 14, low-reflective layers 13C and connecting parts 13B are laminated sequentially in this order.

Adjacent conductive parts 13A are electrically connected to each other by connecting parts 13B. Conductive part 13A and connecting part 13B form second conductive layer 13. Insulating layer 16 is formed so as to cover the upper part of substrate 11.

Then, as shown in FIG. 6B, work-in-process 120 is placed upside down, and cover 17 is bonded to the upper surface of substrate 11. Thus, touch panel 125 is formed. That is to say, in touch panel 125, first conductive layers 12 are formed beneath substrate 11, insulating parts 14 are formed beneath first conductive layers 12, low-reflective layers 13C are formed beneath insulating parts 14, and connecting parts 13B are formed beneath low-reflective layers 13C.

Then, the lower surface of insulating layer 16 is mounted on a display screen such as a liquid crystal display device (not shown). In FIG. 6B, operation surface 50 is an upper surface of cover 17.

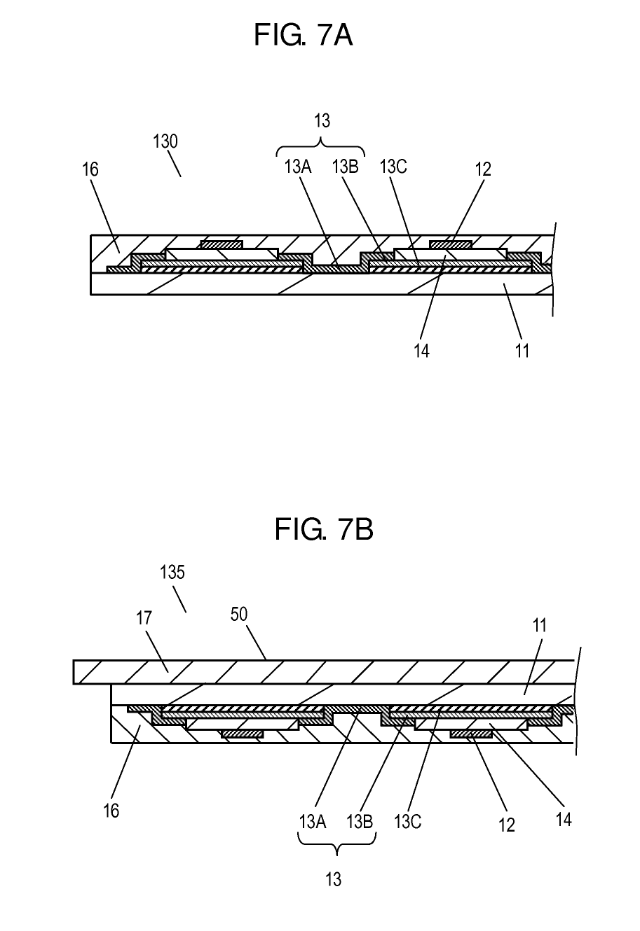

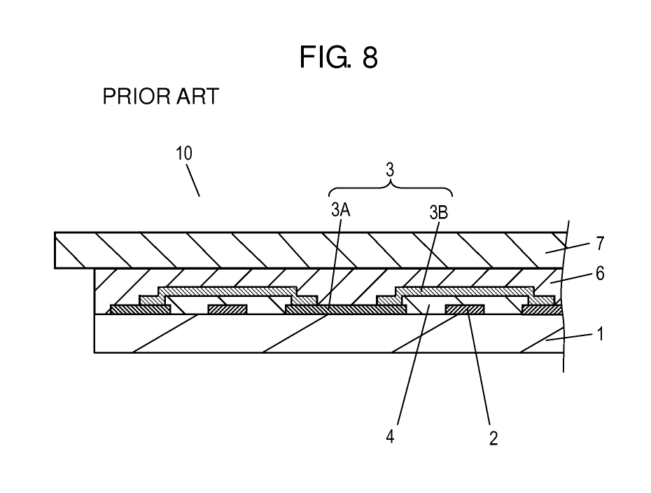

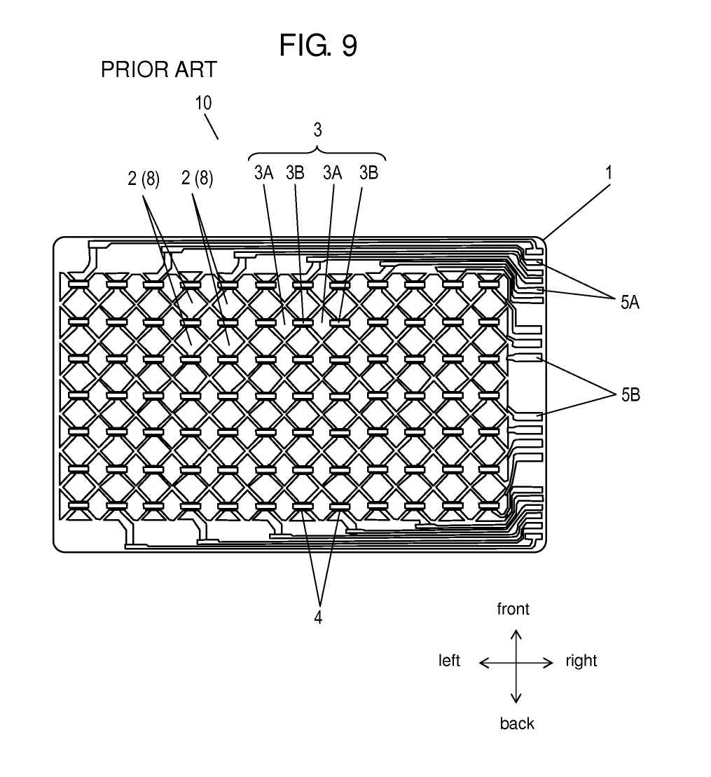

FIG. 7A is a sectional view of work-in-process 130 of touch panel 135 in accordance with the present embodiment. FIG. 7B is a sectional view of touch panel 135 in accordance with the present embodiment. As work-in-process 130, low-reflective layers 13C, connecting parts 13B, and insulating parts 14 are laminated sequentially in this order from the upper surface of substrate 11. First conductive layers 12 and conductive parts 13A are formed thereon.

Adjacent conductive parts 13A are electrically connected to each other by connecting parts 13B. Conductive part 13A and connecting part 13B form second conductive layers 13. Insulating layer 16 is formed so as to cover the upper part of substrate 11.

Then, as shown in FIG. 7B, work-in-process 130 is placed upside down, and cover 17 is bonded to the upper surface of substrate 11. Thus, touch panel 135 is formed. That is to say, in touch panel 135, low-reflective layers 13C are formed beneath substrate 11, connecting parts 13B are formed beneath low-reflective layers 13C, insulating parts 14 are formed beneath connecting parts 13B, and first conductive layers 12 are formed beneath insulating parts 14.

Then, the lower surface of insulating layer 16 is mounted on a display screen such as a liquid crystal display device (not shown). In FIG. 7B, operation surface 50 is an upper surface of cover 17.

Note here that in touch panel 125 and touch panel 135, each first conductive layer 12 is formed in a belt shape in which corners of a plurality of square-shaped electrodes 18 are connected to each other. Conductive parts 13A are formed in a square shape in a square-shaped gap portion.

With the above-mentioned configuration, external light entering from the outside of cover 17 is absorbed by an upper surface of low-reflective layer 13C. As a result, an amount of light reflected from the upper surface of low-reflective layer 13C is suppressed.

Furthermore, as shown in FIGS. 7A and 7B, low-reflective layer 13C is formed in a state in which it is brought into contact with substrate 11, and thereby the shape of low-reflective layer 13C can be made to be flat. Therefore, the reflected light becomes uniform.

Furthermore, in this embodiment, first conductive layer 12 and second conductive layer 13A are made of indium tin oxide, tin oxide, and the like. However, light-transmitting acrylic resin including distributed silver thin lines and the like, and light-transmitting conductive resin of polythiophene, polyaniline, and the like, may be used.

In this way, according to this embodiment, low-reflective layer 13C absorbs external light such as sunlight and lamp light. Therefore, reflection of external light from the upper surface of low-reflective layer 13C is suppressed, thus improving the visibility of the display screen. Note here that in this embodiment, electrode 18 and conductive part 13A are formed in a square shape. However, this embodiment is not limited to this shape, and they may be formed in a circular shape and an elliptical shape.

A touch panel of this embodiment has an advantageous effect that visibility of a display screen is improved, and may be useful as an operation part of various electronic apparatuses.

What is claimed is:

1. A touch panel having an operation surface, comprising:
a plurality of light-transmitting belt-like first conductive layers;
belt-like second conductive layers each including
a plurality of light-transmitting conductive parts formed between the plurality of first conductive layers, and
connecting parts each being insulated from the first conductive layers, crossing over the first conductive layers, and electrically connecting the conductive parts that adjacent to each other,
low-reflective layers formed between each of the connecting parts and the operation surface, and
a substrate that supports the first conductive layers, the second conductive layers, and the low-reflective layers,
wherein surfaces of the low-reflective layers have lower light reflectivity than that of surfaces of the connecting parts.

2. The touch panel of claim 1, wherein each of the low-reflective layers is formed between the substrate and each of the connecting parts.

3. The touch panel of claim 2, wherein the low-reflective layers are brought into contact with the substrate.

4. The touch panel of claim 1, wherein the first conductive layers and the conductive parts are formed on a same plane.

5. The touch panel of claim 1, wherein the first conductive layers and the conductive parts are made of same material.

6. The touch panel of claim 1, wherein each of the first conductive layers is formed between the substrate and each of the connecting parts.

7. The touch panel of claim 1, further comprising an insulating part formed between each of the first conductive layers and each of the conductive parts.

8. The touch panel of claim 7, wherein
the first conductive layers are formed on the substrate,
the insulating parts are formed on the first conductive layers,
the connecting parts are formed on the insulating parts, and
the low-reflective layers are formed on the connecting parts.

9. The touch panel of claim 7, wherein
the connecting parts are formed on the substrate,
the low-reflective layers are formed on the connecting parts,
the insulating parts are formed on the low-reflective layers, and
the first conductive layers are formed on the insulating parts.

10. The touch panel of claim 7, wherein
the first conductive layers are formed beneath the substrate,
the insulating parts are formed beneath the first conductive layers,
the low-reflective layers are formed beneath the insulating parts, and
the connecting parts are formed beneath the low-reflective layers.

11. The touch panel of claim 7, wherein
the low-reflective layers are formed beneath the substrate,
the connecting parts are formed beneath the low-reflective layers,
the insulating parts are formed beneath the connecting parts, and
the first conductive layers are formed beneath the insulating parts.
